(19) United States
(12) Patent Application Publication
(10) Pub. No.: US 2011/0023368 A1
(43) Pub. Date: Feb. 3, 2011

(54) POWER WINDOW APPARATUS

(75) Inventors: Nobuo Mizutani, Toyohashi-shi (JP); Seondo Choi, Chungcheongnam-do (KR)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: ASMO CO., LTD., Shizuoka-ken (JP)

(21) Appl. No.: 12/842,273

(22) Filed: Jul. 23, 2010

(30) Foreign Application Priority Data
Jul. 30, 2009 (JP) 2009-177849

(51) Int. Cl. E05F 15/08; B60J 5/06

(52) U.S. Cl. 49/349

(57) ABSTRACT

A power window apparatus for opening and closing a window glass actuates a window regulator based on power transmitted from the output gear of a motor to the sector gear of a window regulator. A range in which the output gear and the sector gear mesh with each other includes a normal operation range and a low speed operation range. In the normal operation range, the window glass is moved at a normal speed. In the low speed operation range, the window glass is moved at a speed lower than the normal speed from a near-fully closed position to a fully closed position of the window glass.

The present invention relates to a vehicle power window apparatus having an arm window regulator.

### BACKGROUND OF THE INVENTION

As arm window regulators in conventional vehicle power window apparatuses, single-arm window regulators and cross-arm window regulators having a pair of arms have been known. For example, Japanese Laid-Open Patent Publication No. 5-295947 discloses a single-arm window regulator. The single-arm window regulator of the publication includes an electric motor serving as a drive source, an output gear that rotates integrally with the rotary shaft of the electric motor, and a regulator having an arm coupled to a window glass. The output gear meshes with a sector gear provided in the arm. When the motor is driven, rotation of the output gear is transmitted to the sector gear, so that the arm is actuated. Accordingly, the window glass either opens or closes the window.

Recent power window apparatuses are equipped with a catch prevention feature for preventing a foreign object from being caught. When detecting that a foreign object is caught between the closing window glass and the door frame, such an apparatus reverses the movement of the window glass, or starts opening the window glass, thereby releasing the foreign object.

To release a foreign object in a shorter time after it is detected as caught, the responsiveness of the reverse motion of the window glass needs to be improved. However, since inertial force acts on a window glass when it is being closed, it takes time, though short, for the movement of the window glass to be reversed after a foreign object is detected as caught.

In this regard, in a range from the near-fully closed position to the fully closed position of the window glass, where a foreign object is more likely to be caught, the closing speed of the window glass may be controlled, for example, through PWM control of the electric motor, so as to slightly lower the closing speed of the window glass. This reduces the inertial force acting on the window glass when its movement is reversed, so that responsiveness in reversing the motion is improved. However, to control the speed of the window glass, control of the electric motor becomes complicated. This can raise costs of the control device for the electric motor.

### SUMMARY OF THE INVENTION

Accordingly, it is an objective of the present invention to provide a power window apparatus that is capable of changing the speed of a window glass not by controlling, but by simple modification of the structure.

To achieve the foregoing objective and in accordance with one aspect of the present invention, a power window apparatus including a motor unit and a window regulator is provided. The motor unit has an output gear. The window regulator has an arm that supports a window glass. The arm has a sector gear that meshes with the output gear. The window regulator is actuated to selectively open and close the window glass based on power transmitted from the output gear to the sector gear. A range in which the output gear and the sector gear mesh with each other includes a normal operation range, in which the window glass is moved at a normal speed, and a low speed operation range, in which the window glass is moved at a speed lower than the normal speed from a near-fully closed position to a fully closed position.

### BRIEF DESCRIPTION OF THE DRAWINGS

FIG. 1A is a perspective view schematically showing the structure of a vehicle power window apparatus according to one embodiment of the present invention;

FIG. 1B is a perspective view illustrating a motor unit, which is the drive source of the power window apparatus shown in FIG. 1;

FIG. 2A is a plan view illustrating mesh between an output gear and a sector gear in a normal operation range;

FIG. 2B is a cross-sectional view illustrating mesh between the output gear and the sector gear;

FIG. 3A is a plan view illustrating mesh between the output gear and the sector gear in a low speed operation range; and

FIG. 3B is a cross-sectional view illustrating mesh between the output gear and the sector gear.

### DESCRIPTION OF THE PREFERRED EMBODIMENTS

Hereinafter, a preferred embodiment according to the present invention will be described.

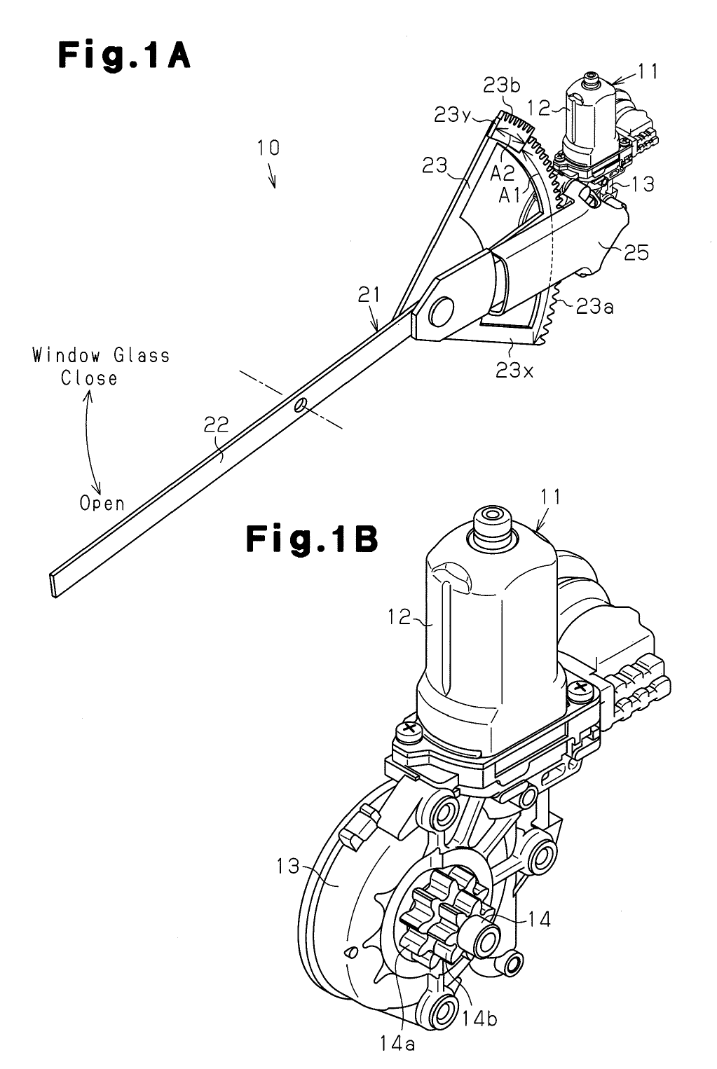

FIG. 1A shows a power window apparatus 10 according to the present embodiment. The power window apparatus 10 is installed in a vehicle door to open and close a window glass (neither is shown), and includes a motor unit 11 serving as a drive source and a cross-arm window regulator 21. The window regulator 21 is driven by the motor unit 11 and actuates the window glass to open or close the window. The window regulator 21 has a pair of arms 22, which intersect each other to form an X. The arms 22 support the window glass. In FIG. 1A, only one of the arms 22 is shown, and the other one is omitted.

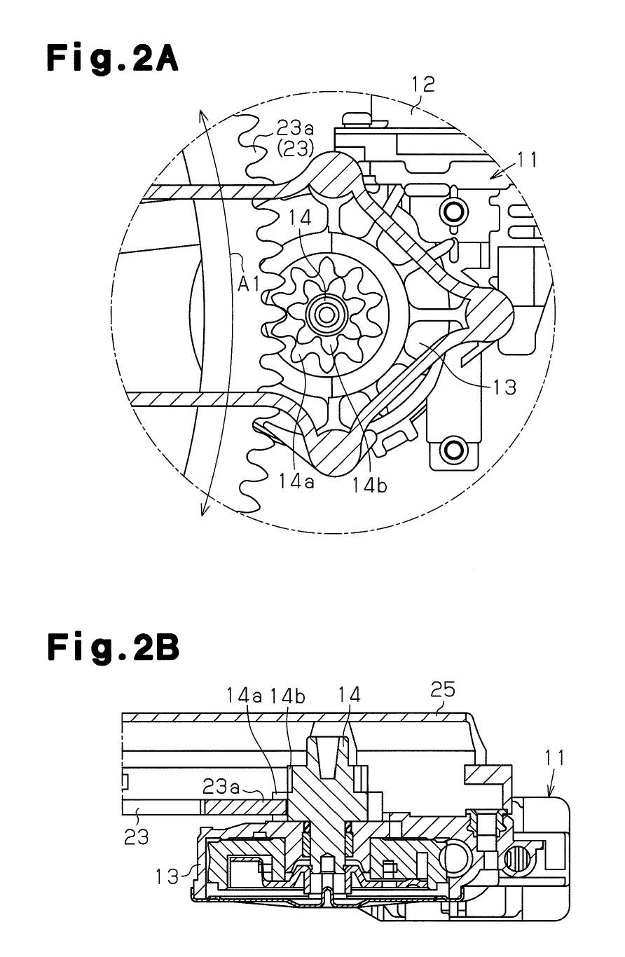

As shown in FIG. 1B, the motor unit 11 is a geared motor unit that includes a motor 12 and a decelerator 13, which are integrated with each other. The motor 12 is a direct-current motor. The decelerator 13 accommodates a speed reducing mechanism (a worm and a worm wheel). The decelerator 13 includes an output gear 14, which is rotated through the speed reducing mechanism. The output gear 14 is a two-step spur gear having a first output gear portion 14a closer to the housing of the decelerator 13 and a second output gear portion 14b closer to the distal end. The first output gear portion 14a and the second output gear portion 14b are formed integrally. The second output gear portion 14b is arranged coaxially with the first output gear portion 14a and has a smaller diameter than that of the first output gear portion 14a. The shape of teeth of the second output gear portion 14b is substantially the same as that of the first output gear portion 14a, while the number of teeth of the second output gear portion 14b is less than that of the first output gear portion 14a. For example, in the present embodiment, the number of teeth of the first output gear portion 14a is set to ten, while the number of teeth of the second output gear portion 14b is set to seven. As shown in FIG. 2A, the tooth tops of the second output gear portion 14b do not protrude further radially outward than the tooth roots of the first output gear portion 14a. The motor unit 11, which has the output gear 14, is attached to an attachment base 25 of the window regulator 21, such that the output gear 14 meshes with a sector gear 23 of one of the two arms 22.

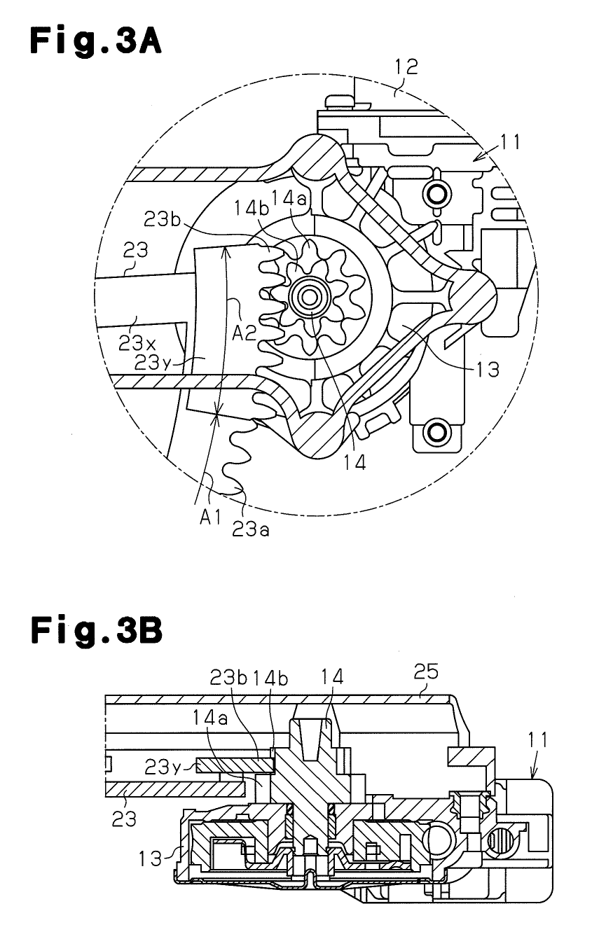

The central angle of the sector gear 23 is approximately 80°. The sector gear 23 has a first sector gear portion 23a and a second sector gear portion 23b at its arcuate peripheral portion. The first sector gear portion 23a ranges over approximately five-sixths of the entire arcuate length from one end of the sector gear 23 from one end thereof, or from the lower end when the sector gear 23 is installed in the vehicle door. The second sector gear portion 23b ranges over the remainder of the peripheral portion above the first sector gear portion 23a, that is, over approximately one-sixth of the entire arcuate length. As shown in FIG. 3B, the sector gear 23 has two-step structure, in which the second sector gear portion 23b is stacked on a side of the first sector gear portion 23a. The radius of the second sector gear portion 23b is larger than the radius of the first sector gear portion 23a. In other words, the second sector gear portion 23b is displaced from the first sector gear portion 23a in the direction of the rotational axis of the sector gear 23, and located radially outward of the first sector gear portion 23a. The first sector gear portion 23a is arranged to mesh with the first output gear portion 14a, and the second sector gear portion 23b is arranged to mesh with the second output gear portion 14b. That is, the speed reduction ratio between the second output gear portion 14b and the second sector gear portion 23b is greater than the speed reduction ratio between the first output gear portion 14a and the first sector gear portion 23a.

As shown in FIGS. 2A and 2B, a range A1, in which the first output gear portion 14a and the first sector gear portion 23a mesh with each other, is a normal operation range in which the window glass is moved at a normal speed through the window regulator 21. The range A1 corresponds to a part of the opening and closing operation range of the window glass and ranges from the fully open position to a near-fully closed position that is approximately one-sixth to the fully closed position. As shown in FIGS. 3A and 3B, a range A2, in which the second output gear portion 14b and the second sector gear portion 23b mesh with each other, is a low speed operation range in which the window glass is moved at a slow speed through the window regulator 21. The range A2 corresponds to a range from the near-fully closed position to the fully closed position.

The second sector gear portion 23b is produced as a separate part 23y including teeth and a fixing portion, for example, by pressing an iron plate. The remainder (a sector gear main body 23x), which includes the first sector gear portion 23a, is produced by pressing an iron plate like the second sector gear portion 23b. The part 23y, which has the second sector gear portion 23b, is fixed, for example, through welding, to one side of the sector gear main body 23x, so as to be located at one end of the tooth row of the first sector gear portion 23a.

The power window apparatus 10 has a window ECU (not shown) that controls the motor unit 11 to open and close the window glass. The window ECU is located, for example, in the motor unit 11. In addition to the control for opening and closing the window glass, the window ECU executes catch prevention control for preventing a foreign object from being caught between the window glass and the door frame. In the catch prevention control, if a foreign object is detected as caught between the window glass and the door frame while the window glass is being closed, the movement of the window glass is reversed to opening movement, so that the foreign object is released.

A foreign object is more likely to be caught in a range between the near-fully closed position and the fully closed position of the window glass. Since this range corresponds to the low speed operation range A2 in the range in which the sector gear 23 meshes with the output gear 14, the closing movement of the window glass is relatively slow in this range. Accordingly, the inertial force of the window glass is reduced. This improves the responsiveness of the reverse action of the window glass, so that a foreign object is released promptly after it is detected as caught.

The present embodiment has the following advantages.

(1) In the present embodiment, the range in which the sector gear 23 provided on the arm 22 of the window regulator 21 meshes with the output gear 14 of the motor unit 11 includes the normal operation range A1, in which the window glass is moved at a normal speed, and the low speed operation range A2, in which the window glass is moved at a low speed from the near-fully closed position to the fully closed position. The configuration for causing the window glass to move from the near-fully closed position to the fully closed position at a speed lower than the speed in the range from the fully open position to the near-fully closed position is accomplished by a mechanical structure of the sector gear 23, not by control of the motor unit 11. The window glass moves at a low speed in a range from the near-fully closed position to the fully closed position, in which a foreign object is more likely to be caught between the window glass and the door frame. This reduces the inertial force acting on the window glass, so that the responsiveness of the reverse action is improved. Accordingly, a foreign object is released promptly after it is detected as caught.

(2) In the present embodiment, the output gear 14 has the first output gear portion 14a and the second output gear portion 14b. The sector gear 23 has the first sector gear portion 23a, which meshes with the first output gear portion 14a, and the second sector gear portion 23b, which meshes with the second output gear portion 14b. The speed reduction ratio between the second output gear portion 14b and the second sector gear portion 23b is greater than the speed reduction ratio between the first output gear portion 14a and the first sector gear portion 23a. The mesh between the output gear 14 and the sector gear 23 is switched between the normal operation range A1, in which the second output gear portion 14b meshes with the first output gear portion 14a, and the low speed operation range A2, in which the second sector gear portion 23b meshes with the second output gear portion 14b. That is, the combination of the meshing gear portions changes between the operation ranges A1 and A2, so that the speed reduction ratio between the meshing gears changes between the operation ranges A1 and A2. The closing speed of the window glass can be changed by such a simple structure. Also, since the speed of the movement of the window glass from the near-fully closed position to the fully closed position is reduced by the speed reduction ratio between the meshing gears, the torque is increased in this range. This increases the torque in the range where a force for completing the closure is required. Accordingly, the size of the motor unit 11 can be reduced.

(3) In the present embodiment, the second sector gear portion 23b is produced as the part 23y, which is separate from the first sector gear portion 23a. The part 23y is fixed to the sector gear main body 23x, which includes the first sector gear portion 23a. Therefore, the range of the second sector gear portion 23b (the range of the low speed operation range A2) is easily set, and the speed reduction ratio (the degree of speed reduction) is easily changed. Also, the sector gear main body 23x, which has the first sector gear portion 23a, may be commonly used as a component for a sector gear of an apparatus that does not change the operation speed.

(4) In the present embodiment, the first and second output gear portions 14a, 14b are formed integrally with the output gear 14. Therefore, the number of components and the number of manufacturing steps of the motor unit 11 are not increased.

(5) In the present embodiment, the first and second output gear portions 14a, 14b of the output gear 14 are displaced from each other in the axial direction to form a two-step structure, and the first and second sector gear portions 23a, 23b of the sector gear 23 are displaced from each other in the axial direction to form a two-step structure. This allows the mesh to be easily changed.

The preferred embodiment of the present invention may be modified as follows.

In the illustrated embodiment, the opening and closing operation range of the window glass is divided into the normal operation range A1 and the low speed operation range A2. The normal operation range A1 is a range from the fully open position to the near-fully closed position, which is a position one sixth to the fully closed position. The low speed operation range A2 is a range from the near-fully closed position to the fully closed position. However, the operation ranges A1, A2 may be changed as necessary. The low speed operation range A2 may be set in between the fully open position and a position near the fully open position.

In the illustrated embodiment, the second sector gear portion 23b is produced as the part 23y, which is separate from the first sector gear portion 23a, and the part 23y is fixed through welding to the sector gear main body 23x, which includes the first sector gear portion 23a. However, the technique for fixing is not limited to welding. For example, the fixing may be achieved by screws. If the second sector gear portion 23b is formed integrally with the sector gear 23, the number of components and the number of manufacturing steps of the window regulator 21 are not increased. When the second sector gear portion 23b is formed integrally with the sector gear 23, the second sector gear portion 23b is formed by bending after press-cutting, so as to achieve a two-step structure of the sector gear portions 23a, 23b.

In the illustrated embodiment, the first and second output gear portions 14a, 14b are formed integrally to form the output gear 14. However, the output gear portions 14a, 14b may be formed separately and assembled.

In the illustrated embodiment, the present invention is applied to a power window apparatus having a catch prevention feature. However, the present invention may be applied to a power window apparatus that does not have the catch prevention feature.

What is claimed is:

1. A power window apparatus comprising:
a motor unit having an output gear; and
a window regulator having an arm that supports a window glass, the arm having a sector gear that meshes with the output gear,
wherein the window regulator is actuated to selectively open and close the window glass based on power transmitted from the output gear to the sector gear, and
wherein a range in which the output gear and the sector gear mesh with each other includes a normal operation range, in which the window glass is moved at a normal speed, and a low speed operation range, in which the window glass is moved at a speed lower than the normal speed from a near-fully closed position to a fully closed position.

2. The power window apparatus according to claim 1, wherein:
the output gear has a first output gear portion and a second output gear portion;
the sector gear has a first sector gear portion and a second sector gear portion;
the first output gear portion and the first sector gear portion mesh with each other in the normal operation range;
the second output gear portion and the second sector gear portion mesh with each other in the low speed operation range; and
the speed reduction ratio between the second output gear portion and the second sector gear portion is greater than the speed reduction ratio between the first output gear portion and the first sector gear portion.

3. The power window apparatus according to claim 2, wherein the second sector gear portion is produced as a part separate from the first sector gear portion and is fixed to a sector gear main body that includes the first sector gear portion.

4. The power window apparatus according to claim 2, wherein the first output gear portion and the second output gear portion are formed integrally as the output gear.

5. The power window apparatus according to claim 2, wherein:
the output gear has a two-step structure in which the first and second output gear portions are displaced from each other in the axial direction; and
the sector gear has a two-step structure in which the first and second sector gear portions are displaced from each other in the axial direction.
